(19) United States
(12) Patent Application Publication
(10) Pub. No.: US 2015/0075091 A1
(43) Pub. Date: Mar. 19, 2015

(54) Adjustable support device for a frame member and installation method

(71) Applicants: Paul Arne Nesbø, Raholt (NO); Øyvind Brochmann, Hagan (NO)

(72) Inventors: Paul Arne Nesbø, Raholt (NO); Øyvind Brochmann, Hagan (NO)

(21) Appl. No.: 14/382,556

(22) PCT Filed: Mar. 8, 2012
(86) PCT No.: PCT/EP2012/054026

§ 371 Date: Oct. 24, 2014

(51) Int. Cl. E06B 1/60; E06B 1/04; E06B 7/00

(52) U.S. Cl. CPC E06B 1/6076; E06B 7/00; E06B 1/04
USPC 52/126.7; 52/745.15

(57) ABSTRACT

An adjustable support device (1) for a frame member (8) comprises a stem (2a) having fastening means (2b, 6) for releasably connecting the stem to a foundation (10; 13), and a support element (3) for the frame member, connected to one end of the stem. A tool interface portion (7) is accessible for an operating tool (15) when the frame member is resting on the support element (3) and configured such that the distance between the foundation and the frame member may be adjusted by the operating tool when a frame member is resting on the support element. The tool interface portion (7) comprises in one embodiment at least one pair of parallel, opposing faces (7a) which are configured for connection to the adjustment tool (15).

### FIELD OF THE INVENTION

The invention concerns an adjustable support device which with suitable accessories may be used for adjusting the height, level and sideways clearance when installing windows and doors in various building constructions. More specifically, the invention concerns an adjustable support device for a frame member, comprising a stem having fastening means for releasably connecting the stem to a foundation, and the adjustable support device also comprising a support element for the frame member, connected to one end of the stem, and a method of supporting and adjusting a frame member with respect to a foundation, by using at least two adjustable support devices according to the invention.

### BACKGROUND OF THE INVENTION

Installing window frames and door frames in building constructions such that they are level, is a time consuming and cumbersome task. Especially when the foundation onto which the frame is to be installed is slanting and not level. This is in fact a very common situation where the foundation is a brick wall or a cast wall, and in particular in older buildings which are being refurbished.

The state of the art involves using wedges made of wood or plastic as frame supports and adjustment means, an example of which is illustrated in FIG. 1. The wedges 17 are inserted towards each other, one from each side of the bottom frame member 8 frame or side frame members 18 of the window 16, and pushed towards each other until the desired height adjustment and level has been obtained. The wedges 17 are normally fixed by a nail, extending through the wedges and into the foundation 10. If the wedges are too long, compared to the width of the foundation, they must be cut following installation. Each assembly of wedges 17 occupies a significant volume between the foundation and the frame; these volumes cannot be insulated and are hence in effect thermal bridges in the finished building construction. This gives a higher U-value (a measure of the rate of heat loss through a material) than what is desired.

The state of the art includes NO 315431, which discloses an adjustable fastener for joining a window frame to a surrounding stationary building structure. The fastener comprises an externally threaded bushing which is designed to be screwed into a pre-drilled hole through the frame. A combined fastening and support screw fits inside the bushing, and the frame may thus be levelled by rotating the screw. NO 142823, DE 7128103 and EP 0878591 all disclose fasteners for door frames.

The known means for installing and adjusting (e.g. levelling) window frames and door frames are cumbersome and time-consuming in use, some require pre-drilled holes, and others create unwanted thermal bridges.

The present applicant has devised and embodied this invention in order to overcome these shortcomings and to obtain further advantages.

### SUMMARY OF THE INVENTION

The invention is set forth and characterized in the main claim, while the dependent claims describe other characteristics of the invention.

It is thus provided an adjustable support device for a frame member, comprising a stem having fastening means for releasably connecting the stem to a foundation, and the adjustable support device also comprising a support element for the frame member, connected to one end of the stem. The adjustable support device is characterized by a tool interface portion which is accessible for an operating tool when the frame member is resting on the support element and configured such that the distance between the foundation and the frame member may be adjusted by the operating tool when a frame member is resting on the support element.

In one embodiment, the tool interface portion comprises at least one pair of parallel, opposing faces which are configured for connection to the adjustment tool.

In one embodiment, the support element is a plate member and the tool interface portion is arranged on an edge of the plate member. The adjustable support device preferably comprises distance indication means for indicating the distance between the foundation and the frame member. The distance indication means are in one embodiment markings at regular intervals on the stem.

In one embodiment, the support element comprises a recessed portion configured for connection to a screw driver, bit or similar, and the recessed portion is arranged in the part of the support element which is configured for abutting against the frame member.

It is also provided a method of supporting and adjusting a frame member with respect to a foundation, by using at least two adjustable support devices according to the invention, characterized by the steps of:

a) installing a first adjustable support device by screwing or inserting its stem a desired distance into the foundation;
b) installing a second adjustable support device by screwing or inserting its stem a distance into the foundation;
c) connecting a level gauge between the first and second adjustable support devices;
d) adjusting the distance between the foundation and the support element of the second adjustable support device until the desired orientation has been achieved.

The distance in step b) may be an arbitrary distance. Step c) may comprise the placement of a level on the support member of each of the adjustable support devices.

The invention makes it possible to adjust the height of the adjustable support device with respect to the support even when a frame is resting on the support element.

### BRIEF DESCRIPTION OF THE DRAWINGS

These and other characteristics of the invention will be clear from the following description of a preferential form of embodiment, given as a non-restrictive example, with reference to the attached drawings wherein:

FIG. 1 illustrates prior art support and adjustment devices for a window frame;

FIG. 2 is a perspective view of an embodiment of the adjustable support device according to the invention;

FIG. 3 is horizontal cross-sectional drawing showing the adjustable support device as illustrated in FIG. 2, in use underneath a window frame in a foundation of wood;

FIG. 4 is horizontal cross-sectional drawing showing the adjustable support device as illustrated in FIG. 2, in use underneath a window frame in a foundation of concrete;

FIG. 5 shows a tool configured for operating the embodiment of the adjustable support device shown in FIG. 2; and

FIG. 6 illustrates a method of levelling a frame by using the adjustable support device according to the invention.

### DETAILED DESCRIPTION OF A PREFERENTIAL EMBODIMENT

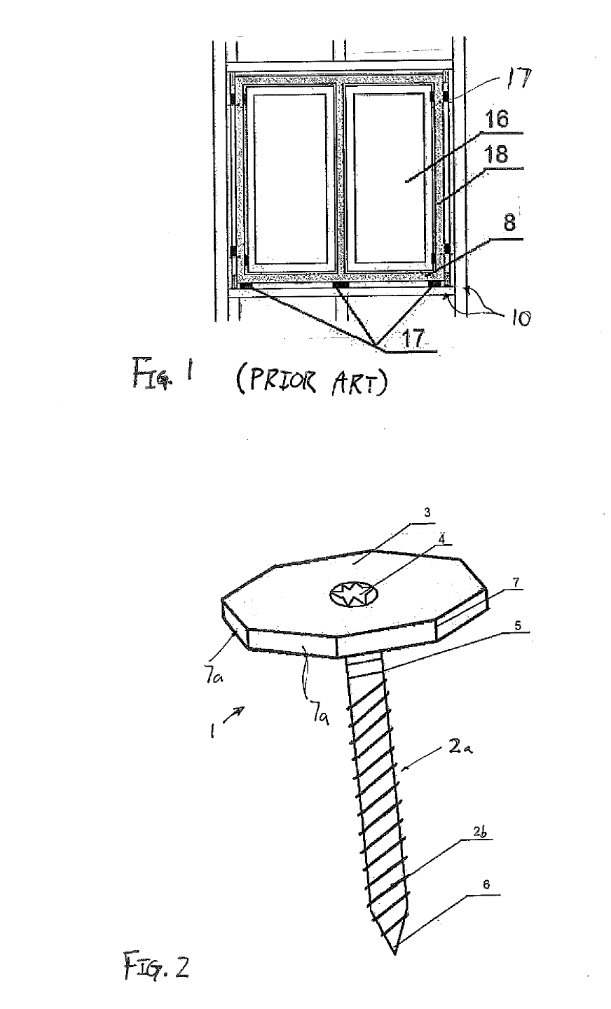

FIG. 2 is a perspective view of an embodiment of the adjustable support device 1 according to the invention. The device, which in the following also will be referred to as an adjustment screw 1, comprises a stem 2a with external threads 1b and a pointed end 6. The stem is dimensioned for the weight which the screw is intended to carry and configured for connection to the applicable foundation. The materials of the foundation may typically be wood, Siporex, metal, Leca (“Light Expanded Clay Aggregate”), brick or concrete.

The adjustment screw 1 furthermore comprises a support plate 3 and an interface portion 4 for a screw driver (not shown) or similar. In FIG. 1, the interface portion 4 is in the form of a recessed hexagonal receptacle for a bit or screw driver.

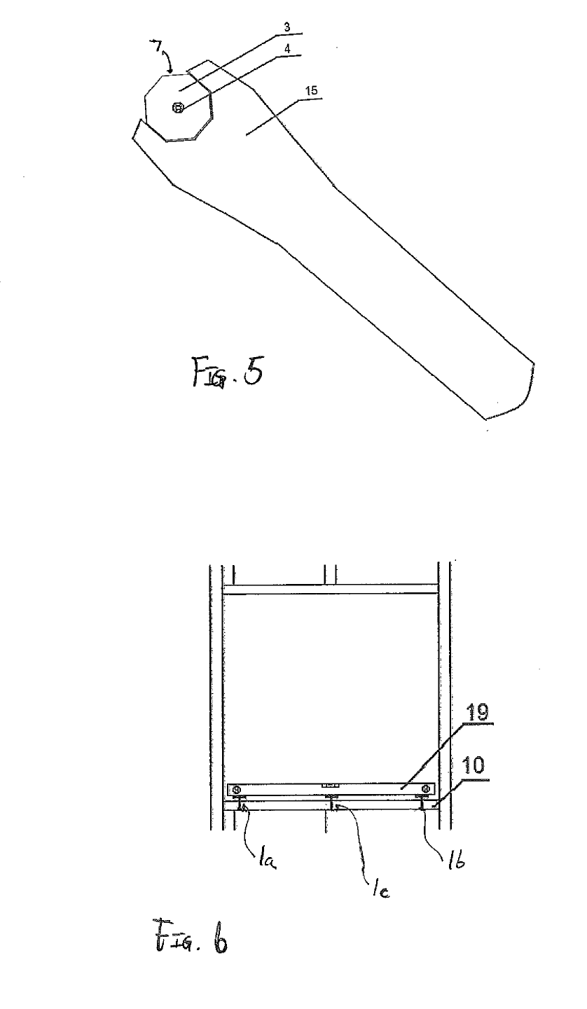

The support plate 3 comprises an edge 7 configured for interface with a suitable operating tool 15 (see FIG. 5); the figures illustrating an octagonal edge 7 having pairs of parallel and opposing faces 7a. The support plate 3 is dimensioned according to relevant weight and surface area requirements.

The upper part of the stem 2a comprises distance indicator markings 5, whereby the operator visually may verify the height of the support plate, i.e. its distance from the foundation.

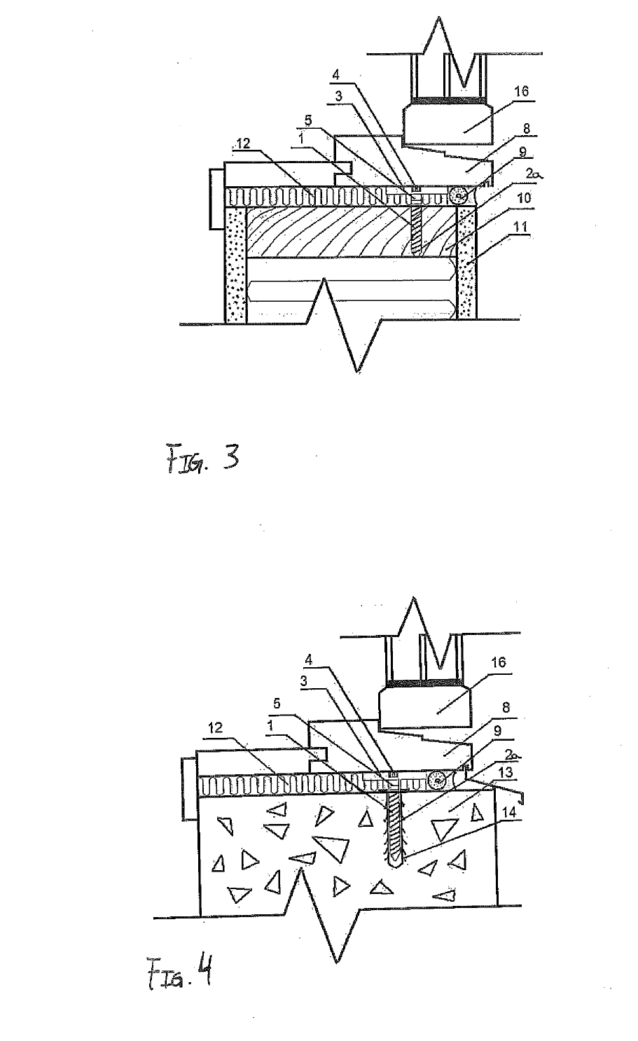

FIG. 3 is a horizontal view of the adjustment screw in use for supporting and adjusting a window having a bottom frame member 8. The stem 2a extends into a foundation of wood 10 and allows an external seal 9 to be fitted around the frame, and insulation 12 to be distributed evenly between the foundation 10 and the bottom frame member 8. Reference number 11 indicates external panelling. The invention thus provides for a better U-value that that of the prior art (FIG. 1).

In FIG. 4, the stem 2a extends into a plug 14 which has been inserted into a pre-drilled hole in a foundation of concrete 13. Similar to the configuration illustrated by FIG. 3, the invention allows an external seal 9 to be fitted around the frame, and insulation 12 to be distributed evenly between the foundation 10 and the bottom frame member 8. The invention thus provides for a better U-value that that of the prior art (FIG. 1).

FIG. 5 illustrates an adjustment tool (or key) 15, connected to the octagonal edge 7 of the support plate 3. Referring again to FIGS. 3 and 4, it is understood that the adjustment tool 15 may easily be inserted between the bottom frame member 8 and the wood foundation 10 (or concrete foundation 13) and connected to the edge 7 even when the support plate 3 supports a frame. The height and/or level of the frame (and hence the window or door, etc.) may thus easily be adjusted.

FIG. 6 illustrates a method of using the adjustment screw. Adjustment screws 1a-c are fastened to the wood foundation 10, e.g. by means of a driving bit connected to the interface 4 (see FIG. 2). Preferably, one screw 1a,b is positioned at each reveal (corner) and one screw 1c in the middle. The first screw 1a is adjusted to the desired level, e.g. by using the distance indicators 15. A second screws 1b is installed, a level 19 is placed on top of the screws' support plates 3, and each adjustment screw 1a-c is adjusted (by the tool 15; see FIG. 5) until the level is correct. The window or door may then be installed in a level frame.

1. An adjustable support device for a frame member, comprising a stem releasably connected to a foundation, the adjustable support device also comprising a support element for the frame member, connected to one end of the stem, and further comprising
a tool interface portion which is accessible for an operating tool when the frame member is resting on the support element, said tool interface being configured such that the distance between the foundation and the frame member may be adjusted by the operating tool when a frame member is resting on the support element.

2. An adjustable support device according to claim 1, wherein the tool interface portion comprises at least one pair of parallel, opposing faces which are configured for connection to the adjustment tool.

3. An adjustable support device according to claim 1 or claim 2, wherein the support element is a plate member and the tool interface portion is arranged on an edge of the plate member.

4. An adjustable support device according to claim 3, further comprising distance indication means for indicating the distance between the foundation and the frame member.

5. An adjustable support device according to claim 4, wherein the distance indication means comprise markings at regular intervals on the stem.

6. An adjustable support device according to claim 4, wherein the support element comprises a recessed portion configured for connection to a screw driver, bit or similar, and the recessed portion is arranged in the part of the support element which is configured for abutting against the frame member.

7. A method of supporting and adjusting a frame member with respect to a foundation by using at least two adjustable support devices according to any one of claims 1-6, characterized by the steps of:
a) installing a first adjustable support device by screwing or inserting its stem a desired distance into the foundation;
b) installing a second adjustable support device by screwing or inserting its stem a distance into the foundation;
c) connecting a level gauge between the first and second adjustable support devices;
d) adjusting the distance between the foundation and the support element of the second adjustable support device until the desired orientation has been achieved.

8. The method of claim 7, wherein the distance in step b) is an arbitrary distance.

9. The method of claim 7 or claim 8, wherein step c) comprises placement of a level on the support member of each of the adjustable support devices.
